(19) United States
(12) Patent Application Publication
(10) Pub. No.: US 2025/0246852 A1
(43) Pub. Date: Jul. 31, 2025

(54) LEVER-TYPE CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Shinji NOZAKI, Mie (JP); Daisuke SAITO, Mie (JP)

(21) Appl. No.: 18/705,124

(22) PCT Filed: Oct. 27, 2022
(86) PCT No.: PCT/JP2022/040124

§ 371 Date: Apr. 26, 2024

(30) Foreign Application Priority Data
Nov. 8, 2021 (JP) 2021-181777

(51) Int. Cl. H01R 13/641; H01R 13/629

(52) U.S. Cl. CPC H01R 13/641; H01R 13/62933

(57) ABSTRACT

A lever-type connector includes a connector housing connectable to a mating connector and including a housing body having an assembly surface and rail receiving portions disposed on the assembly surface and to be engaged with a vehicle body panel, a lever having a code arrangement surface and to be assembled with the connector housing rotatably from a connection start position to a connection completion position, and a two-dimensional code disposed on the code arrangement surface. The code arrangement surface is a surface facing outward both when the lever is at the connection start position and when the lever is at the connection completion position, facing the same side as the assembly surface when the lever is at the connection start position and facing a side different from the assembly surface when the lever is at the connection completion position.

### TECHNICAL FIELD

A technique disclosed by this specification relates to a lever-type connector.

### BACKGROUND

A connector is known which is provided with a connection detection function for detecting whether or not a male housing and a female housing are properly connected.

Such a connector is, for example, provided with a connector housing, an identifier disposed on a surface of the connector housing, a lever for assisting the connection of the connector housing and a mating connector and a position assurance lock displaceable from a release position to an engagement position when the lever is at a connection completion position. The identifier is covered by the position assurance lock when the position assurance lock is at the release position, and exposed from the position assurance lock and accessible by a detecting device or the like when the position assurance lock is at the engagement position. By accessing the exposed identifier, the completion of the connection of the connector housing and the mating connector is detected and recorded.

### PRIOR ART DOCUMENT

### Patent Document

Patent Document 1: JP 2017-162797 A

### SUMMARY OF THE INVENTION

### Problems to be Solved

In the above configuration, there is a concern that the identifier is damaged and becomes unreadable by the rubbing of the position assurance lock and the identifier when the position assurance lock is displaced from the release position for covering the identifier to the engagement position for releasing the identifier. Further, since the identifier is covered by the position assurance lock when the lever is not at the connection completion position, whether or not the identifier is in a normally readable state cannot be confirmed. Thus, there is a concern that the identifier cannot be normally read after the connection completion of the connector and the mating connector and it cannot be detected/recorded that the connector has been properly connected to the mating connector.

### Means to Solve the Problem

A lever-type connector disclosed by this specification is provided with a connector housing connectable to a mating connector, the connector housing including a housing body having an assembly surface and an assembling portion disposed on the assembly surface, the assembling portion being engaged with an external member, a lever having a code arrangement surface, the lever being assembled with the connector housing rotatably from a connection start position to a connection completion position, and an identifier disposed on the code arrangement surface, the code arrangement surface being a surface facing outward both when the lever is at the connection start position and when the lever is at the connection completion position, facing the same side as the assembly surface when the lever is at the connection start position and facing a side different from the assembly surface when the lever is at the connection completion position.

### Effect of the Invention

According to the lever-type connector disclosed by this specification, it can be reliably detected/recorded that the lever-type connector has been properly connected to the mating connector.

### BRIEF DESCRIPTION OF THE DRAWINGS

FIG. 1 is a perspective view of a lever-type connector of an embodiment.

FIG. 2 is a perspective view of a connector housing of the embodiment.

FIG. 3 is a perspective view showing the connector housing of the embodiment when viewed from a direction different from that of FIG. 2.

FIG. 4 is a front view of the connector housing of the embodiment.

FIG. 5 is a perspective view of a lever of the embodiment.

FIG. 6 is an enlarged perspective view enlargedly showing one cam plate in the lever of the embodiment.

FIG. 7 is a bottom view showing a state where the lever is at a connection start position in the lever-type connector of the embodiment.

FIG. 8 is an enlarged bottom view enlargedly showing around a code arrangement recess of FIG. 7.

FIG. 9 is a side view showing a state where the lever-type connector of the embodiment is mounted on a vehicle body panel and in an initial stage of connection to the mating connector.

FIG. 10 is a back view showing the state where the lever-type connector of the embodiment is mounted on the vehicle body panel and in the initial stage of connection to the mating connector.

FIG. 11 is a side view showing a state where the lever-type connector of the embodiment is mounted on the vehicle body panel and is being connected to the mating connector.

FIG. 12 is a back view showing the state where the lever-type connector of the embodiment is mounted on the vehicle body panel and is being connected to the mating connector.

FIG. 13 is a side view showing a state where the lever-type connector of the embodiment is mounted on the vehicle body panel and is completely connected to the mating connector.

FIG. 14 is a back view showing the state where the lever-type connector of the embodiment is mounted on the vehicle body panel and is completely connected to the mating connector.

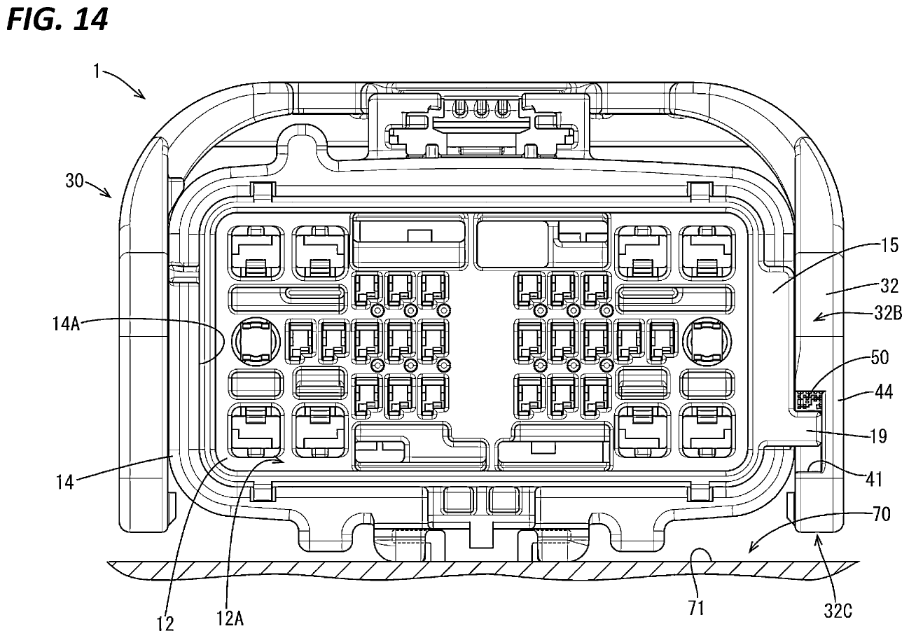

FIG. 15 is an enlarged back view enlargedly showing around the code arrangement recess of FIG. 14.

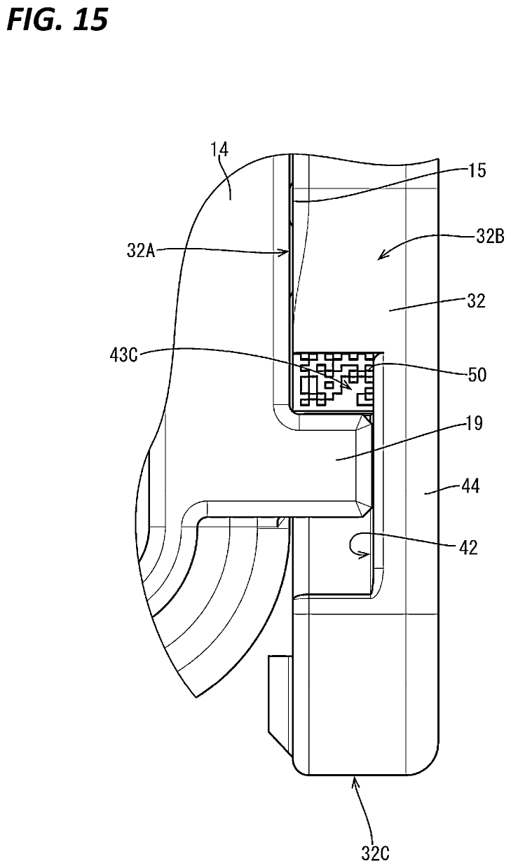

### DETAILED DESCRIPTION TO EXECUTE THE INVENTION

### Summary of Embodiments

(1) The lever-type connector disclosed by this specification is provided with a connector housing connectable to a mating connector, the connector housing including a housing body having an assembly surface and an assembling portion disposed on the assembly surface, the assembling portion being engaged with an external member, a lever having a code arrangement surface, the lever being assembled with the connector housing rotatably from a connection start position to a connection completion position, and an identifier disposed on the code arrangement surface, the code arrangement surface being a surface facing outward both when the lever is at the connection start position and when the lever is at the connection completion position, facing the same side as the assembly surface when the lever is at the connection start position and facing a side different from the assembly surface when the lever is at the connection completion position.

Note that “facing the same side as the assembly surface” means not only a case where the code arrangement surface is disposed in parallel to the assembly surface, but also a case where the code arrangement surface is inclined with respect to the assembly surface within such a range as to be visually confirmable from the assembly surface side.

According to the above configuration, since the code arrangement surface is a surface facing outward both when the lever is at the connection start position and when the lever is at the connection completion position, it can be avoided that the identifier rubs against another member to be damaged and become unreadable during an assembly operation of the lever-type connector with the mating connector. Further, since the identifier cannot be easily detected in a single state where the lever-type connector is not assembled with the external member, whether or not the identifier is undetectable due to damage can be easily confirmed before the assembly operation. On the other hand, with the lever-type connector assembled with the external member, the identifier cannot be detected when the lever is at the connection start position and the identifier is detectable when the lever is at the connection completion position. In the above way, proper connection of the lever-type connector to the mating connector can be reliably detected/recorded.

(2) In the lever-type connector of (1) described above, the housing body may have a wire draw-out surface facing a side different from the assembly surface, a wire draw-out opening for drawing out a wire being open in the wire draw-out surface, and the code arrangement surface may be a surface facing the same side as the wire draw-out surface when the lever is at the connection completion position.

Note that “facing the same side as the wire draw-out surface” means not only a case where the code arrangement surface is disposed in parallel to the wire draw-out surface, but also a case where the code arrangement surface is inclined with respect to the wire draw-out surface within such a range as to be visually confirmable from the wire draw-out surface side.

According to this configuration, since a certain wide space is necessary to arrange the wire drawn out through the wire draw-out surface near the wire draw-out surface, another member is hardly arranged and a space for allowing a detecting device to be brought closer is easily secured. In this way, the identifier can be reliably detected when the lever is at the connection completion position.

(3) In the lever-type connector of (1) or (2) described above, the lever may include a code arrangement recess and the code arrangement surface may be facing an internal space of the code arrangement recess.

According to this configuration, the code arrangement surface does not contact the outer surface of the connector housing and the surface of the external member. Thus, it is reliably avoided that the identifier disposed on the code arrangement surface is damaged by the connector housing or the external member according to the rotation of the lever. Further, since the code arrangement surface is separated from an outside space by a surrounding part of the code arrangement recess in the lever, it can be avoided that the identifier is erroneously detected from a direction different from an intended direction although the lever is not at the connection completion position.

(4) In the lever-type connector of (3) described above, the code arrangement recess may be disposed in a facing surface facing the connector housing in the lever.

According to this configuration, since the code arrangement surface is surrounded by the surrounding part of the code arrangement recess in the lever and the connector housing, it can be avoided that the identifier is erroneously detected from a direction different from the intended direction although the lever is not at the connection completion position.

(4) In the lever-type connector of any one of (1) to (3) described above, the connector housing may include a shielding projection projecting toward the lever, shifted from the code arrangement surface when the lever is at the connection completion position and covering the code arrangement surface from the side different from the assembly surface when the lever is between the connection start position and the connection completion position.

According to this configuration, since the identifier is covered by the shielding projection while the lever is being rotated, it can be avoided that the identifier is erroneously read although the connection of the lever-type connector and the mating connector is not completed yet.

(5) In the lever-type connector of any one of (1) to (4) described above, the code arrangement surface may be disposed to be inclined with respect to the assembly surface when the lever is at the connection start position.

According to this configuration, while the lever is being rotated, the code arrangement surface is kept at such an angle that the identifier is hardly detected by the detecting device from the side different from the assembly surface. In this way, it can be avoided that the identifier is erroneously read although the connection of the lever-type connector and the mating connector is not completed yet.

### Details of Embodiment

A specific example of a technique disclosed by this specification is described below with reference to the drawings. Note that the present invention is not limited to these illustrations, but is represented by claims and intended to include all changes in the scope of claims and in the meaning and scope of equivalents.

### [Overall Configuration of Lever-Type Connector 1]

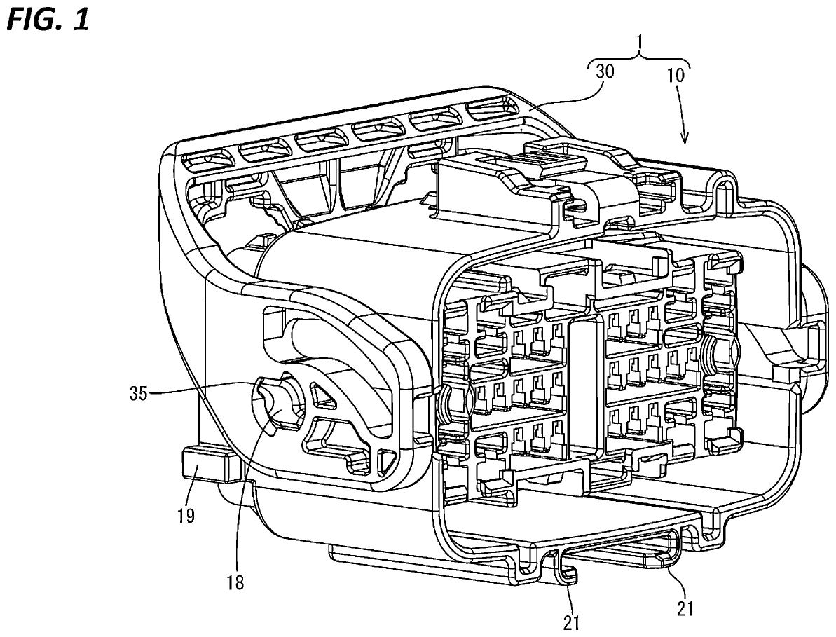

A lever-type connector 1 of this embodiment is a connector to be connected to a mating connector 60 including cam followers 62 by being assembled with a vehicle body panel 70 (an example of an external member) and, as shown in FIG. 1, provided with a connector housing 10 including rail receiving portions 21 to be assembled with the vehicle body panel 70 and a lever 30 to be assembled with this connector housing 10.

### [Connector Housing 10]

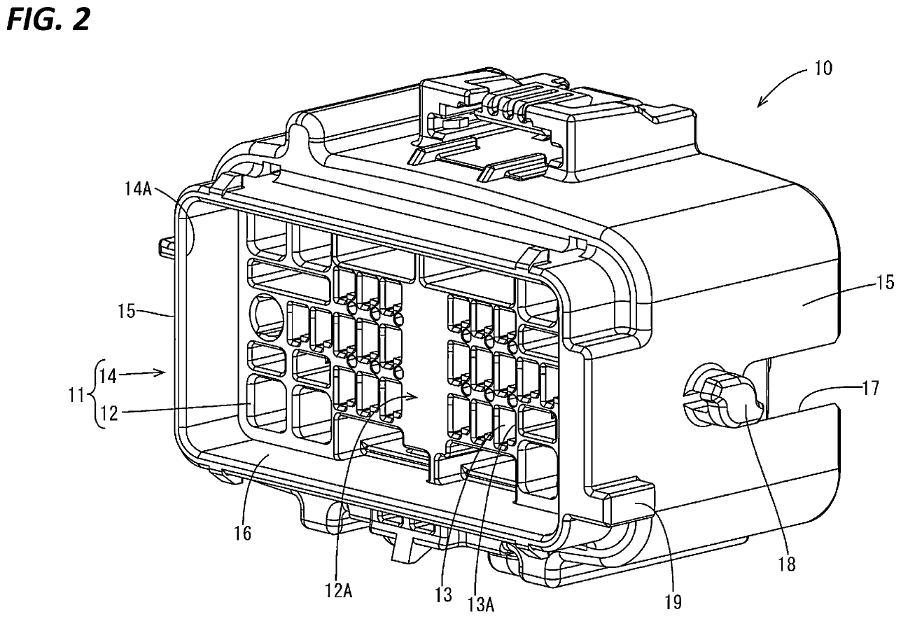

The connector housing 10 is made of synthetic resin and, as shown in FIGS. 2, 3 and 4, provided with a housing body 11, two rotary shafts 18, two rail receiving portions 21 and a shielding projection 19 projecting outward from the housing body 11. The housing body 11 includes a block-shaped terminal holding portion 12 for holding terminal fittings and a receptacle 14 in the form of a rectangular tube arranged to surround this terminal holding portion 12 and configured to receive the mating connector 60 inside.

As shown in FIG. 2, the terminal holding portion 12 includes a wire draw-out surface 12A and a plurality of cavities 13 having openings (wire insertion openings 13A) in the wire draw-out surface 12A. A female terminal fitting and an end part of a wire connected to the female terminal fitting are held inside each cavity 13.

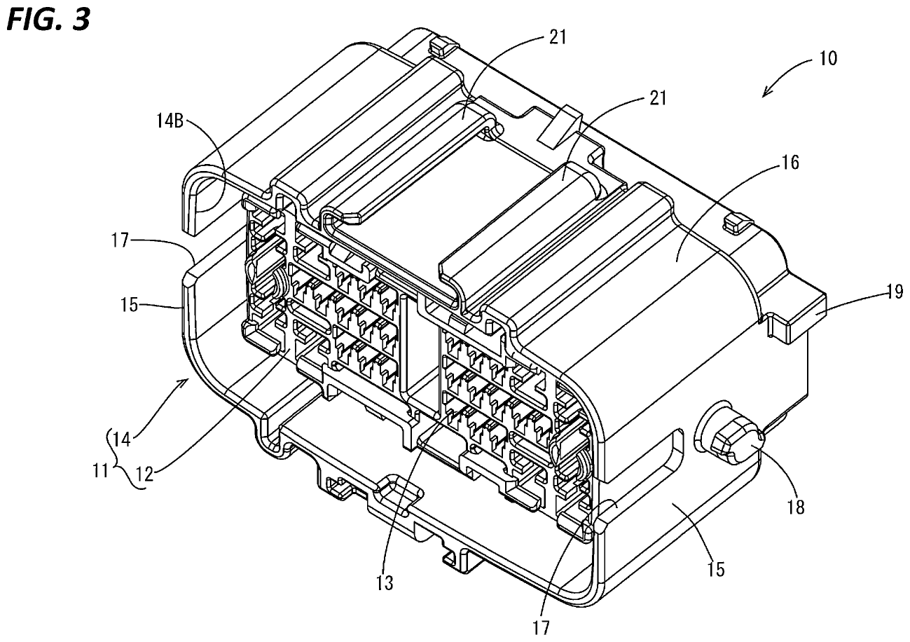

The receptacle 14 is in the form of a tube having openings on both ends. One of the two openings of the receptacle 14 serves as a wire draw-out opening 14A and the wire draw-out surface 12A is facing outward through the wire draw-out opening 14A as shown in FIG. 2. The other of the two openings serves as a fitting opening 14B for allowing the entrance of the mating connector 60 as shown in FIG. 3. The receptacle 14 includes two lever mounting walls 15 perpendicular to the wire draw-out surface 12A and an assembly wall 16 connecting the two lever mounting walls 15. Each of the two lever mounting walls 15 includes a receiving groove 17 extending from the opening edge of the fitting opening 14B and configured such that the cam follower 64 of the mating connector 60 is inserted thereinto. The two rotary shafts 18 respectively have a substantially cylindrical shape and are respectively disposed on the outer surfaces of the two lever mounting walls 15.

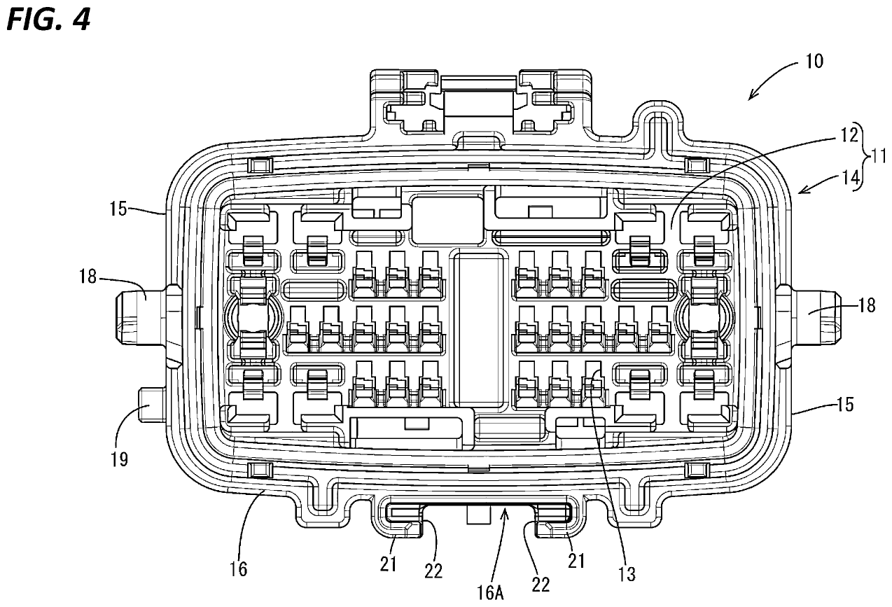

As shown in FIGS. 3 and 4, the two rail receiving portions 21 are disposed in parallel to each other on the outer surface (assembly surface 16A) of the assembly wall 16. Each rail receiving portion 21 includes a mounting groove 22 disposed in a surface facing the mating rail receiving portion 21.

As shown in FIG. 2, the shielding projection 19 is a projection projecting outward from one lever mounting wall 15 and disposed adjacent to the opening edge of the wire draw-out opening 14A.

### [Lever 30]

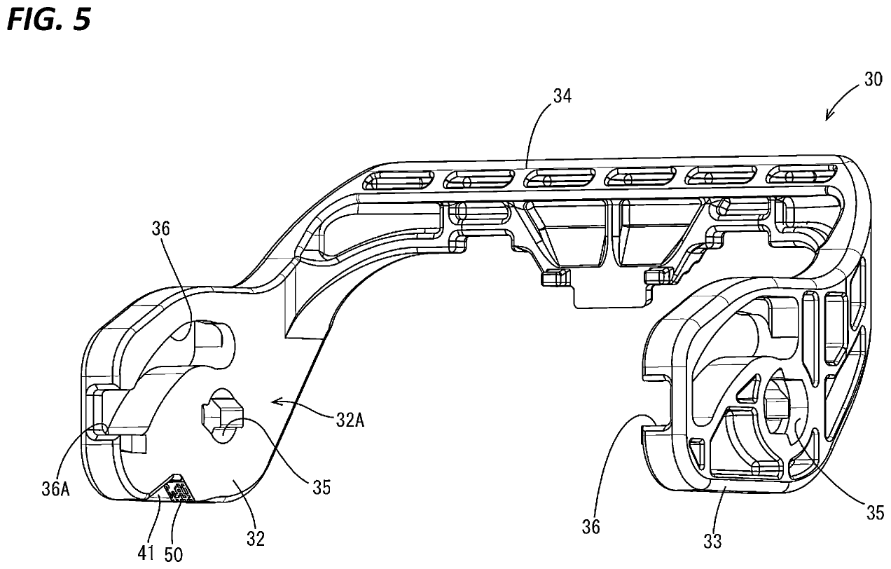

The lever 30 is a member for assisting connection to and separation from the mating connector 60 by the principle of leverage. The lever 30 is a substantially U-shaped member made of synthetic resin and including, as shown in FIG. 5, two cam plates 32, 33 and a rotating portion 34 coupling the two cam plates 32, 33.

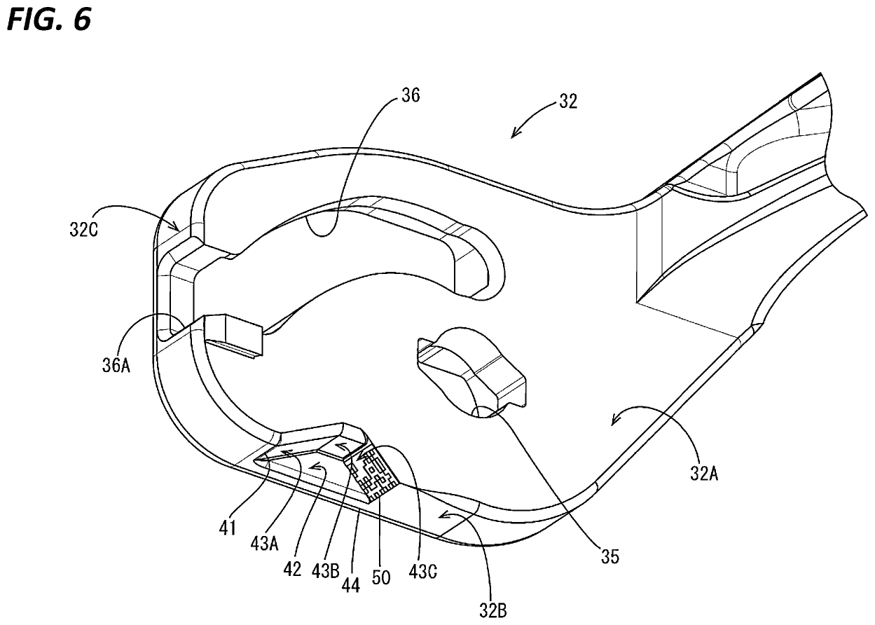

As shown in FIGS. 5 and 6, one cam plate 32 is in the form of a thick plate and one of both back and front surfaces serves as a facing surface 32A facing the lever mounting wall 15. The cam plate 32 includes a shaft hole 35 for receiving the rotary shaft 18 and a cam groove 36 disposed in the facing surface 32A for receiving the cam follower 64. The shaft hole 35 is a substantially circular hole penetrating through the cam plate 32. The cam groove 36 includes a cam entrance opening 36A in one edge of the cam plate 32, and extends backward from this cam entrance opening 36A. The cam groove 36 has such a substantially arc shape as to gradually approach the shaft hole 35, which is a center of rotation of the cam plate 32, from the cam entrance opening 36A toward a back side. The other cam plate 33 is similarly configured.

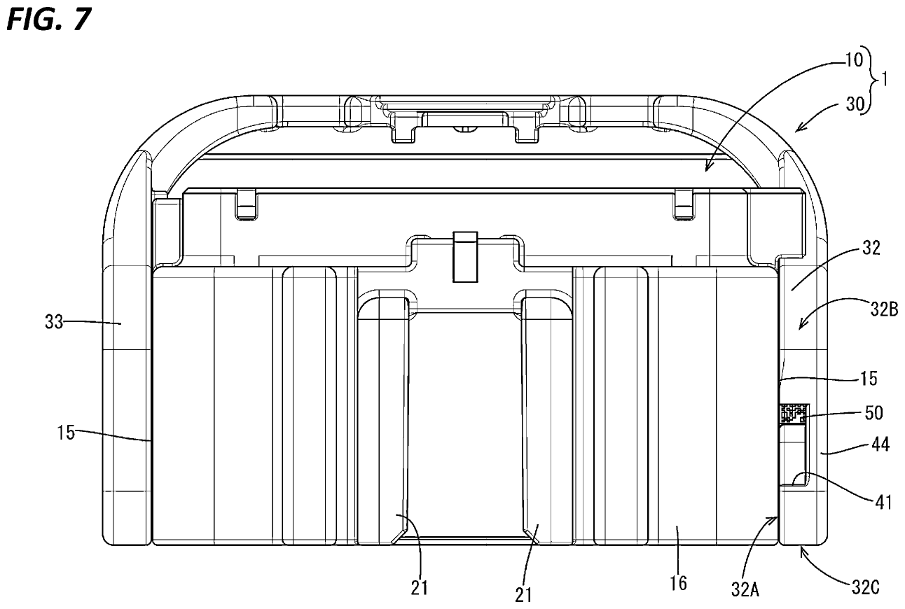

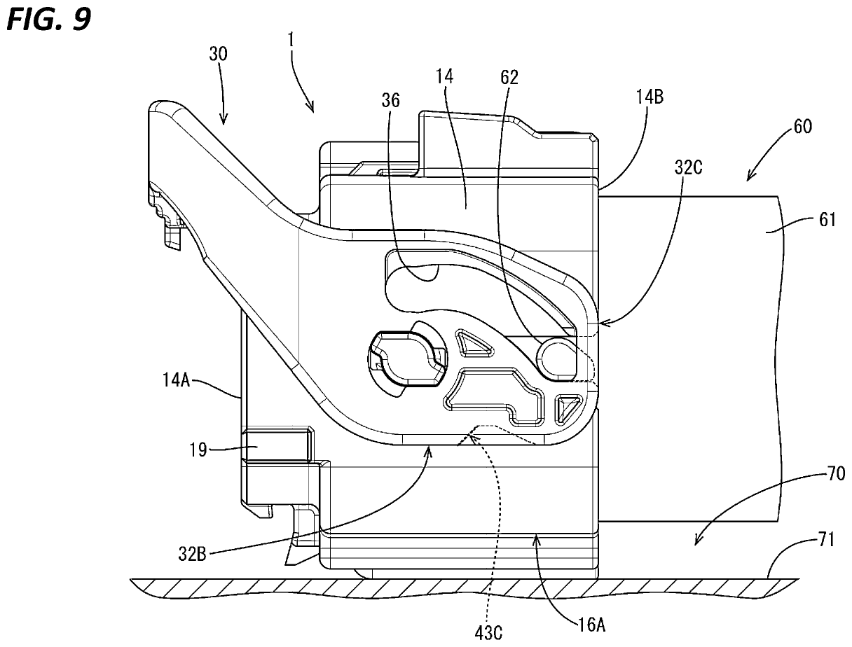

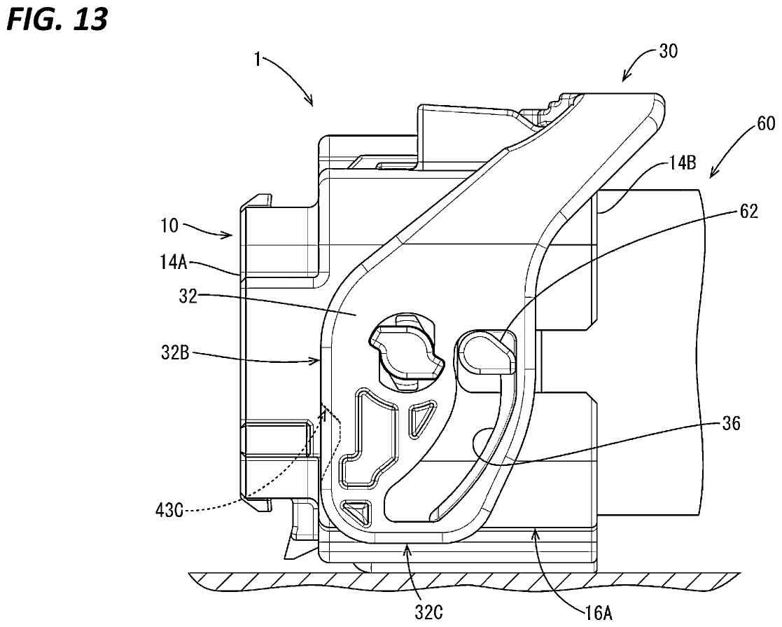

As shown in FIGS. 1 and 7, the lever 30 is mounted over the connector housing 10, the two cam plates 32, 33 are respectively arranged along the lever mounting walls 15, and the rotary shafts 18 are fit into the shaft holes 35. The lever 30 is supported rotatably about the rotary shafts 18 between a connection start position (position shown in FIGS. 1, 7 and 9) and a connection completion position (position shown in FIG. 13) where the mating connector 60 is connected to the connector housing 10 at a proper connection position. The outer peripheral surface of the cam plate 32 includes a first peripheral surface 32B (see FIG. 9) facing the same side as the assembly surface 16A with the lever 30 located at the connection start position and a second outer peripheral surface 32C (see FIG. 13) facing the same side as the assembly surface 16A with the lever 30 completely rotated.

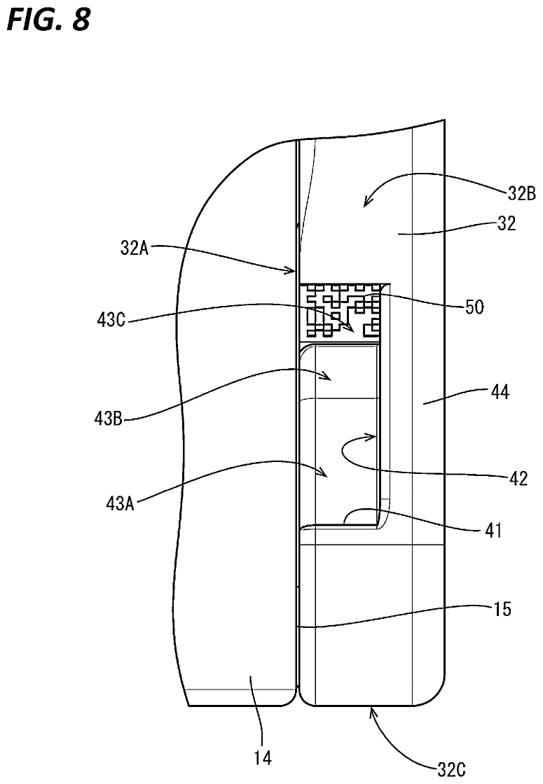

The one cam plate 32 includes a code arrangement recess 41 disposed in the facing surface 32A. As shown in FIGS. 6, 7 and 8, the code arrangement recess 41 is a recess defined by a step surface 42 facing the lever mounting wall 15 and a first side wall surface 42A, a second side wall surface 43B and a code arrangement surface 43C disposed around the step surface 42 and linking the step surface 42 and the facing surface 32A, and open in the facing surface 32A and the first outer peripheral surface 32B. The first side wall surface 43A, the second side wall surface 43B and the code arrangement surface 43C are disposed in this order from a side near the second outer peripheral surface 32C. The first side wall surface 43A extends from the first outer peripheral surface 32B and is inclined more away from the first outer peripheral surface 32B with distance from the second outer peripheral surface 32C. The code arrangement surface 43C is inclined toward the first outer peripheral surface 32B with distance from the second outer peripheral surface 32C and connected to the first outer peripheral surface 32B. An angle of inclination of the code arrangement surface 43C is roughly 45° with respect to the first outer peripheral surface 32B. The code arrangement surface 43C is facing the same side as the assembly surface 16A with the lever 30 located at the connection start position, and facing the same side as the wire draw-out surface 12A with the lever 30 located at the connection completion position (see FIGS. 9 and 13). The code arrangement surface 43C is facing outward through an opening of the code arrangement recess 41 on the side of the first outer peripheral surface 32B. The code arrangement surface 43C is facing an internal space of the code arrangement recess 41, and does not contact the outer surface of the connector housing 10 and the surface of the vehicle body panel 70.

In the cam plate 32, a part sandwiched between the step surface 42 and the outer surface of the cam plate 32 on a side opposite to the facing surface 32A serves as a separation wall 44 separating the code arrangement surface 43C from an outside space of the code arrangement recess 41.

### [Two-Dimensional Code 50]

As shown in FIGS. 6, 7 and 8, a two-dimensional code 50 (an example of an identifier) is disposed on the code arrangement surface 43C. The two-dimensional code 50 is, for example, formed by laser printing on the code arrangement surface 43C. Information such as “connection completion” and a “lot number” is, for example, recorded in the two-dimensional code 50. The recorded information can be read by detecting this two-dimensional code 50 using a detecting device such as a code reader. The information read by the detecting device is recorded in a recording device.

### [Mating Connector 60]

The mating connector 60 is made of synthetic resin and provided with a mating housing 61 to be accommodated into the receptacle 14 and configured to receive the terminal holding portion 12 inside and two cam followers 62 disposed on the outer surface of the mating housing 61 as shown in FIG. 9. Although only one cam follower 62 corresponding to the cam groove 36 disposed in the one cam plate 32 is shown in FIGS. 9, 11 and 13, the two cam followers 62 are respectively provided at positions corresponding to the two cam grooves 36 of the two cam plates 32, 33.

### [Manufacturing Process of Lever-Type Connector 1]

In manufacturing the lever-type connector 1, the two-dimensional code 50 is first printed on the code arrangement surface 43C of the lever 30. Thereafter, the lever 30 is assembled with the connector housing 10 and set at the connection start position.

After the completion of the manufacturing process, whether or not the two-dimensional code 50 is normally detectable is confirmed for the lever-type connector 1 before an assembly process. This confirmation step is, for example, performed by testing whether or not the two-dimensional code 50 can be read by the detecting device.

In a state where the lever-type connector 1 is not assembled with the vehicle body panel 70 and not connected to the mating connector 60 (state where the lever 30 is at the connection start position), the code arrangement surface 43C and the two-dimensional code 50 disposed thereon can be visually confirmed from outside and detected by the detecting device. More specifically, as shown in FIG. 7, the code arrangement surface 43C is facing the same side as the assembly surface 16A and the two-dimensional code 50 arranged on the code arrangement surface 43C can be visually confirmed and detected by the detecting device from the side of the assembly surface 16A. In this way, a confirmation step can be smoothly performed.

The lever-type connector 1, for which it was confirmed that the two-dimensional code 50 was normally detectable, proceeds to the next assembly process.

### [Assembly Process of Lever-Type Connector 1]

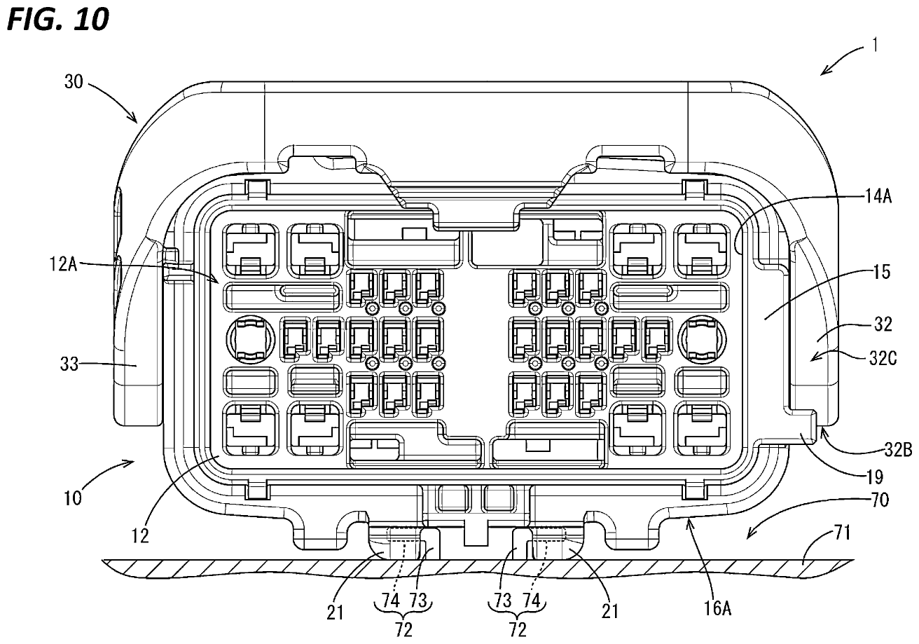

The lever-type connector 1 is assembled with the vehicle body panel 70 with the lever 30 disposed at the connection start position. As shown in FIG. 10, the vehicle body panel 70 is provided with a panel body 71 and two rails 72 disposed on the surface of the panel body 71 and to be respectively engaged with the two rail receiving portions 21. Each rail 72 includes a vertical rail 73 projecting from the surface of the panel body 71 and a horizontal rail 74 extending in a direction opposite to the other vertical rail 73 from the extending end of the vertical rail 73. The horizontal rails 74 enter the mounting grooves 22 and are engaged with the rail receiving portions 21, whereby the lever-type connector 1 is fixed to the vehicle body panel 70.

With the lever-type connector 1 assembled with the vehicle body panel 70, the assembly surface 16A is disposed to face the panel body 71 as shown in FIG. 9. Since the lever 30 is disposed at the connection start position, the code arrangement surface 43C is disposed to face the same side as the assembly wall 16, i.e. face the vehicle body panel 70. Accordingly, the detecting device cannot be brought closer to the two-dimensional code 50 and the two-dimensional code 50 cannot be read by the detecting device since the two-dimensional code 50 disposed on the code arrangement surface 43C is concealed by the vehicle body panel 70 or the vehicle body panel 70 stands in the way even if the two-dimensional code 50 is not completely concealed. In this way, it can be avoided that the two-dimensional code 50 is erroneously read although the mating connector 60 is not connected.

Note that, as shown in FIG. 10, the code arrangement surface 43C and the two-dimensional code 50 disposed thereon can be neither visually confirmed nor detected by the detecting device from the side of the wire draw-out surface 12A.

Subsequently, the mating connector 60 is connected to the lever-type connector 1. The lever 30 assists an operation of connection to the mating connector 60 by relatively pulling the mating connector 60 toward the connector housing 10 by cam action of the cam grooves 36 and the cam followers 61 as being rotated from the connection start position to the connection completion position.

First, the mating housing 61 enters the receptacle 14 through the fitting opening 14B and the lever-type connector 1 is lightly connected to the mating connector 60. The cam followers 62 enter the cam grooves 36.

Subsequently, the lever 30 is rotated from the connection start position toward the connection completion position. According to the rotation of the lever 30, the connector housing 10 is relatively pulled toward the mating connector 60 by cam action based on the engagement of the cam followers 62 and the cam grooves 36. Here, the code arrangement surface 43C is facing the internal space of the code arrangement recess 41 and does not contact the outer surface of the connector housing 10 and the surface of the vehicle body panel 70. Thus, it is avoided that the two-dimensional code 50 disposed on the code arrangement surface 43C contacts the connector housing 10 or the vehicle body panel 70 to be damaged according to the rotation of the lever 30.

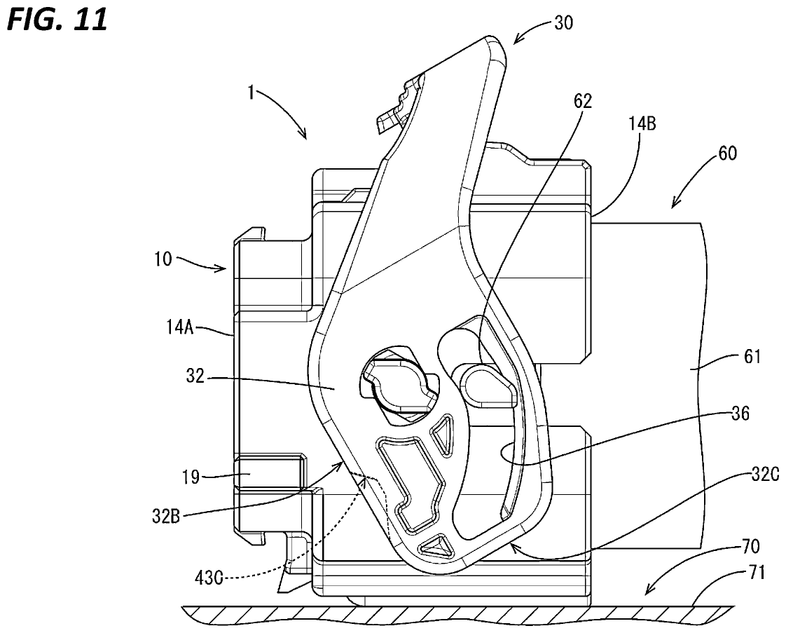

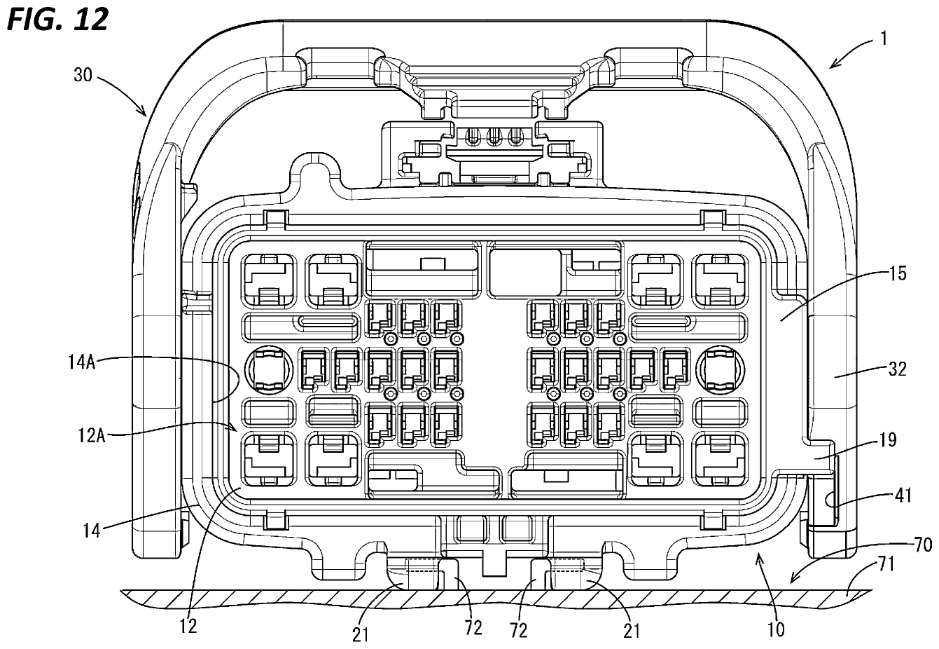

As the lever 30 approaches the connection completion position, the posture thereof is so changed that the first outer peripheral surface 32B faces the same side as the wire draw-out surface 12A. Along with this, the code arrangement surface 43C also changes the posture thereof to face the same side as the wire draw-out surface 12A. However, since the code arrangement surface 43C is inclined with respect to the first outer peripheral surface 32B, the lever 30 is kept at such an angle that the code arrangement surface 43C is hardly detected by the detecting device from the side of the wire draw-out surface 12A (left side of FIG. 11) as shown in FIG. 11 in a state during the rotation of the lever 30. Further, the connector housing 10 is provided with the shielding projection 19. As shown in FIG. 12, this shielding projection 19 covers the code arrangement surface 43C and the two-dimensional code 50 disposed thereon from the side of the wire draw-out surface 12A to hinder reading when the lever 30 is at an intermediate position during rotation from the connection start position to the connection completion position. It can be avoided by these that the two-dimensional code 50 is erroneously read although the connection of the lever-type connector 1 and the mating connector 50 is not completed yet.

As shown in FIG. 13, the code arrangement surface 43C is arranged to face the same side as the wire draw-out surface 12A in a state where the lever 30 has reached the connection completion position. Further, the shielding projection 19 is shifted to a side closer to the assembly surface 16A than the code arrangement surface 43C, thereby releasing the shielding of the two-dimensional code 50 by the shielding projection 19. In this way, the detecting device can be brought closer to the two-dimensional code 50 from the side of the wire draw-out surface 12A and detect the two-dimensional code 50. Here, the code arrangement surface 43C is disposed to face the internal space of the code arrangement recess 41, and the separation wall 44 and the lever mounting wall 15 separate the code arrangement surface 43C from an outside space. In this way, the two-dimensional code 50 arranged on the code arrangement surface 43C is accessible only from the side of the first outer peripheral surface 32B, and it can be avoided that the two-dimensional code 50 is erroneously detected from a direction different from an intended direction although the lever 30 is not at the connection completion position.

If the two-dimensional code 50 is detected by the detecting device, it is judged that the connector housing 10 has reached the connection completion position with respect to the mating connector 60 and the information included in the two-dimensional code 50 is recorded in the recording device.

### Functions and Effects

As described above, according to this embodiment, the lever-type connector 1 is provided with the connector housing 10 connectable to the mating connector 60 and including the housing body 11 having the assembly surface 16A and the rail receiving portions 21 disposed on the assembly surface 16A and to be engaged with the vehicle body panel 70, the lever 30 having the code arrangement surface 43C and to be assembled with the connector housing 10 rotatably from the connection start position to the connection completion position and the two-dimensional code 50 disposed on the code arrangement surface 43C. The code arrangement surface 43C is a surface facing outward both when the lever 30 is at the connection start position and when the lever 30 is at the connection completion position, facing the same side as the assembly surface 16A when the lever 30 is at the connection start position and facing a side different from the assembly surface 16A when the lever 30 is at the connection completion position.

According to the above configuration, since the code arrangement surface 43C is a surface facing outward both when the lever 30 is at the connection start position and when the lever 30 is at the connection completion position, it can be avoided that the two-dimensional code 50 rubs against another member to be damaged and become unreadable during an assembly operation of the lever-type connector 1 with the mating connector 60. Further, since the two-dimensional code 50 cannot be easily detected in a single state where the lever-type connector 1 is not assembled with an external member, whether or not the two-dimensional code 50 is undetectable due to damage can be easily confirmed before the assembly operation. On the other hand, with the lever-type connector 1 assembled with the vehicle body panel 70, the two-dimensional code 50 cannot be detected when the lever 30 is at the connection start position and the two-dimensional code 50 is detectable when the lever 30 is at the connection completion position. In the above way, proper connection of the lever-type connector 1 to the mating connector 60 can be reliably detected/recorded.

Further, the housing body 11 has the wire draw-out surface 12A facing the side different from the assembly surface 16A and having the wire draw-out opening 14A for drawing out the wires open therein, and the code arrangement surface 43C is a surface facing the same side as the wire draw-out surface 12A when the lever 30 is at the connection completion position.

According to this configuration, since a certain wide space is necessary to arrange the wires drawn out through the wire draw-out surface 12A near the wire draw-out surface 12A, another member is hardly arranged and a space for allowing the detecting device to be brought closer is easily secured. In this way, the two-dimensional code 50 can be reliably detected when the lever 30 is at the connection completion position.

Further, the lever 30 includes the code arrangement recess 41 and the code arrangement surface 43C is facing the internal space of the code arrangement recess 41.

According to this configuration, the code arrangement surface 43C does not contact the outer surface of the connector housing 10 and the surface of the vehicle body panel 70. Thus, it is reliably avoided that the two-dimensional code 50 disposed on the code arrangement surface 43C is damaged by the connector housing 10 or the vehicle body panel 70 according to the rotation of the lever 30. Further, since the code arrangement surface 43C is separated from the outside space by a surrounding part (specifically, the separation wall 44) of the code arrangement recess 41 in the lever 30, it can be avoided that the two-dimensional code 50 is erroneously detected from a direction different from the intended direction although the lever 30 is not at the connection completion position.

Further, the code arrangement recess 41 may be disposed in the surface facing the connector housing 10 in the cam plate 32.

According to this configuration, since the code arrangement surface 43C is surrounded by the surrounding part (specifically, the separation wall 44) of the code arrangement recess 41 in the cam plate 32 and the connector housing 10, it can be avoided that the two-dimensional code 50 is erroneously detected from a direction different from the intended direction although the lever 30 is not at the connection completion position.

Further, the connector housing 10 is provided with the shielding projection 19 projecting toward the lever 30, shifted from the code arrangement surface 43C when the lever 30 is at the connection completion position, but covering the code arrangement surface 43C from the side different from the assembly surface 16A when the lever 30 is between the connection start position and the connection completion position.

According to this configuration, since the two-dimensional code 50 is covered by the shielding projection 19 while the lever 30 is being rotated, it can be avoided that the two-dimensional code 50 is erroneously read although the connection of the lever-type connector 1 and the mating connector 60 is not completed yet.

Further, the code arrangement surface 43C is disposed to be inclined with respect to the assembly surface 16A.

According to this configuration, while the lever 30 is being rotated, the code arrangement surface 43C is kept at such an angle that the two-dimensional code 50 is hardly detected by the detecting device from the side different from the assembly surface 16A. In this way, it can be avoided that the two-dimensional code 50 is erroneously read although the connection of the lever-type connector 1 and the mating connector 60 is not completed yet.

### Other Embodiments

(1) Although the identifier is the two-dimensional code in the above embodiment, the identifier may be, for example, a one-dimensional code such as a barcode, characters, numbers, a figure, unevenness or a combination of these.
(2) Although the mating member is the vehicle body panel 70 in the above embodiment, the type of the mating member is not particularly limited and may be a member other than the vehicle body panel.
(3) Although the code arrangement surface 43C is facing the same side as the wire draw-out surface 12A when the lever is at the connection completion position in the above embodiment, an identifier detection direction when the lever is at the connection completion position is not limited to that of the above embodiment and may be, for example, a direction from a connection surface side.
(4) Although the two-dimensional code is arranged on one cam plate 32 in the above embodiment, identifiers may be, for example, arranged on both of the two cam plates. According to this configuration, even if one cam plate is hidden by the wires drawn out from the connector housing, the identifier disposed on the other cam plate can be read and a degree of freedom in routing wires is enhanced.
(5) Although the code arrangement surface 43C is inclined roughly by 45° with respect to the assembly surface 16A with the lever 30 located at the connection start position in the above embodiment, the angle of inclination of the code arrangement surface is not limited to that of the above embodiment, but is arbitrary within such a range that the identifier disposed on the code arrangement surface is visually confirmable and detectable from the side of the assembly surface with the lever located at the connection start position and visually confirmable and detectable from a side different from the assembly surface with the lever located at the connection completion position. Alternatively, the code arrangement surface may be parallel to the assembly surface with the lever located at the connection start position.

### LIST OF REFERENCE NUMERALS

1: lever-type connector
10: connector housing
11: housing body
12: terminal holding portion
12A: wire draw-out surface
13: cavity
13A: wire insertion opening
14: receptacle
14A: wire draw-out opening
14B: fitting opening
15: lever mounting wall
16: assembly wall
16A: assembly surface
17: receiving groove
18: rotary shaft
19: shielding projection
21: rail receiving portion
22: mounting groove
30: lever
32, 33: cam plate
32A: facing surface
32B: first outer peripheral surface
32C: second outer peripheral surface
34: rotating portion
35: shaft hole
36: cam groove
36A: cam entrance opening
41: code arrangement recess
42: step surface
43A: first side wall surface
43B: second side wall surface
43C: code arrangement surface
44: separation wall
50: two-dimensional code (identifier)
60: mating connector
61: mating housing
62: cam follower
70: vehicle body panel (external member)
71: panel body
72: rail
73: vertical rail
74: horizontal rail

1. A lever-type connector, comprising:
a connector housing connectable to a mating connector, the connector housing including a housing body having an assembly surface and an assembling portion disposed on the assembly surface, the assembling portion being engaged with an external member;
a lever having a code arrangement surface, the lever being assembled with the connector housing rotatably from a connection start position to a connection completion position; and
an identifier disposed on the code arrangement surface,
the code arrangement surface being a surface facing outward both when the lever is at the connection start position and when the lever is at the connection completion position, facing the same side as the assembly surface when the lever is at the connection start position and facing a side different from the assembly surface when the lever is at the connection completion position.

2. The lever-type connector of claim 1, wherein:
the housing body has a wire draw-out surface facing a side different from the assembly surface, a wire draw-out opening for drawing out a wire being open in the wire draw-out surface, and
the code arrangement surface is a surface facing the same side as the wire draw-out surface when the lever is at the connection completion position.

3. The lever-type connector of claim 1, wherein the lever includes a code arrangement recess and the code arrangement surface is facing an internal space of the code arrangement recess.

4. The lever-type connector of claim 3, wherein the code arrangement recess is disposed in a facing surface facing the connector housing in the lever.

5. The lever-type connector of claim 1, wherein the connector housing includes a shielding projection projecting toward the lever, shifted from the code arrangement surface when the lever is at the connection completion position and covering the code arrangement surface from the side different from the assembly surface when the lever is between the connection start position and the connection completion position.

6. The lever-type connector of claim 1, wherein the code arrangement surface is disposed to be inclined with respect to the assembly surface when the lever is at the connection start position.
